(19) United States
(12) Patent Application Publication
(10) Pub. No.: US 2006/0290593 A1
(43) Pub. Date: Dec. 28, 2006

(54) Device and method for controlling scanning directions of color signals in flat panel display

(75) Inventors: Ji Hyun Kim, Uiwang-si (KR); Seung Tae Kim, Seoul (KR); Hyuen Hee Bae, Seoul (KR); Jae Yup Lee, Sungnam-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/449,746

(22) Filed: Jun. 9, 2006

(30) Foreign Application Priority Data
Jun. 9, 2005 (KR) 10-2005-0049236
May 23, 2006 (KR) 10-2006-0046182

(51) Int. Cl. G09G 5/00

(52) U.S. Cl. 345/3.3

(57) ABSTRACT

Disclosed herein is a device and method for controlling the scanning directions of color signals in a flat panel display. The method includes the first step of converting digital color data into analog color signals using a plurality of Digital-to-Analog (D/A) converters provided in a driver Integrated Circuit (IC), and the second step of scanning the converted analog color signals onto a flat panel display unit, and controlling the scanning directions of the color signals so that the scanning directions vary on a row basis for each frame.

### BACKGROUND OF THE INVENTION

1. Field of the Invention

The present invention relates generally to a device and method for controlling the scanning directions of color signals in a flat panel display and, more particularly, to a device and method for controlling the scanning directions of color signals in a flat panel display that uses light-emitting devices, such as active matrix type organic light emitting diodes.

2. Description of the Related Art

A flat panel display using a flat panel, in which a plurality of light-emitting devices is arranged in matrix form, is actively being developed. For example, organic Electro Luminescence (EL) devices, which emit light when electricity is applied thereto, are generally used for such a flat panel.

Meanwhile, flat panels using organic EL devices include a simple matrix type flat panel, in which the organic EL devices are arranged in simple matrix form, and an active matrix type flat panel, in which high-performance Active Matrix type Organic Light Emitting Diodes (AMOLEDs), which are achieved by adding Thin Film Transistors (TFTs), that is, active devices, to the organic EL devices, are arranged in matrix form.

FIG. 1 is a block diagram showing the construction of a general flat panel display, and FIGS. 2 and 4 are diagrams showing embodiments in which the scanning directions of color signals vary on a frame basis in the general flat panel display. For example, the flat panel display using the simple matrix type flat panel includes a flat panel display unit, such as a Liquid Crystal Display (LCD) unit.

Furthermore, the flat panel display includes a driver Integrated Circuit (IC) 11 for operating a flat panel display unit 10, and a microcomputer 12 for controlling the operation of the driver IC 11 according to a user's keyed input, thus enabling video data, which is read from a storage unit 13, to be displayed on the screen of the flat panel display unit 10.

Furthermore, analog voltage or analog current, corresponding to the video data, is applied to the respective pixels of the flat panel display, such as the LCD, so that an image corresponding to the video data can be displayed on the screen.

Meanwhile, the driver IC 11 buffers video data read from the storage unit 13, converts the video data corresponding to respective pixels, for example, digital color data, into analog color signals using a plurality of Digital-to-Analog (D/A) converters, and then applies the converted analog color signals to the flat panel display unit 10. In this case, the scanning directions of analog color signals applied to the flat panel display unit 10 vary on a frame basis.

For example, when a color signal (for example, an R signal) of the Nth frame Frame [n] is scanned onto the flat panel display unit 10, the driver IC 11, as shown in FIG. 2, performs scanning while shifting the scanning direction of the color signal in the lower-left diagonal direction.

Then, when a color signal (for example, an R signal) of the N+1th frame Frame [n+1] is scanned onto the flat panel display unit 10, the color signal, as shown in FIG. 3, is scanned in the vertical direction. Subsequently, when a color signal (for example, an R signal) of the N+2th frame Frame [n+2] is scanned onto the flat panel display unit 10, the color signal, as shown in FIG. 4, is scanned in the lower-right diagonal direction.

Accordingly, the scanning directions of color signals scanned onto the flat panel display vary on a frame basis in the lower-left diagonal direction, in the vertical direction, and in the lower-right diagonal direction, so that the phenomenon in which vertical stripe pattern noise is displayed on the screen of the display due to the intrinsic characteristics of the plurality of D/A converters provided in the driver IC 11 can be reduced.

However, as described above, when the scanning directions of color signals are controlled on a frame basis, a problem occurs in that gradient error caused by diagonal stripe pattern noise is incurred.

Therefore, an efficient solution for preventing both the vertical stripe pattern noise and the diagonal stripe pattern noise from occurring in a high-performance flat panel display that uses AMOLEDs is required.

### SUMMARY OF THE INVENTION

Accordingly, the present invention has been made keeping in mind the above problems occurring in the prior art, and an object of the present invention is to provide a device and method for controlling the scanning directions of color signals in a flat panel display, which is capable of controlling the scanning directions of analog color signals, which are scanned onto a flat panel display using light-emitting devices, such as AMOLEDs, on a row basis for each frame, thus efficiently preventing both vertical stripe pattern noise and diagonal stripe pattern noise from occurring.

In order to accomplish the above object, the present invention provides a method of controlling scanning directions of color signals in a flat panel display, the method including the first step of converting digital color data into analog color signals using a plurality of D/A converters provided in a driver IC; and the second step of scanning the converted analog color signals onto a flat panel display unit, and controlling the scanning directions of the color signals so that the scanning directions vary on a row basis for each frame.

In addition, the present invention provides a device for controlling scanning directions of color signals in a flat panel display, the device including a plurality of D/A converters for converting digital color data into analog color signals; a plurality of input multiplexers, each for selecting one of a predetermined number of pieces of digital color data to be input to the D/A converters, and inputting the selected digital color data to a corresponding D/A converter; a plurality of output multiplexers, each for selecting one of color signals input through a predetermined number of D/A converters and outputting the selected color signal to a light-emitting device of a pixel; and a controller for controlling the scanning directions of the color signals so that the scanning directions vary on a row basis for each frame in such a way as to control operation of the respective input and output multiplexers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a general flat panel display;

FIGS. 2 and 4 are diagrams showing embodiments in which the scanning directions of color signals vary on a frame basis in the general flat panel display;

FIGS. 5 to 7 are diagrams illustrating embodiments of a device and method for controlling the scanning directions of color signals in a flat panel display according to the present invention; and

FIGS. 8 to 10 are diagrams showing embodiments in which the scanning directions of color signals vary on a row basis for each frame in the flat panel display according to the present invention.

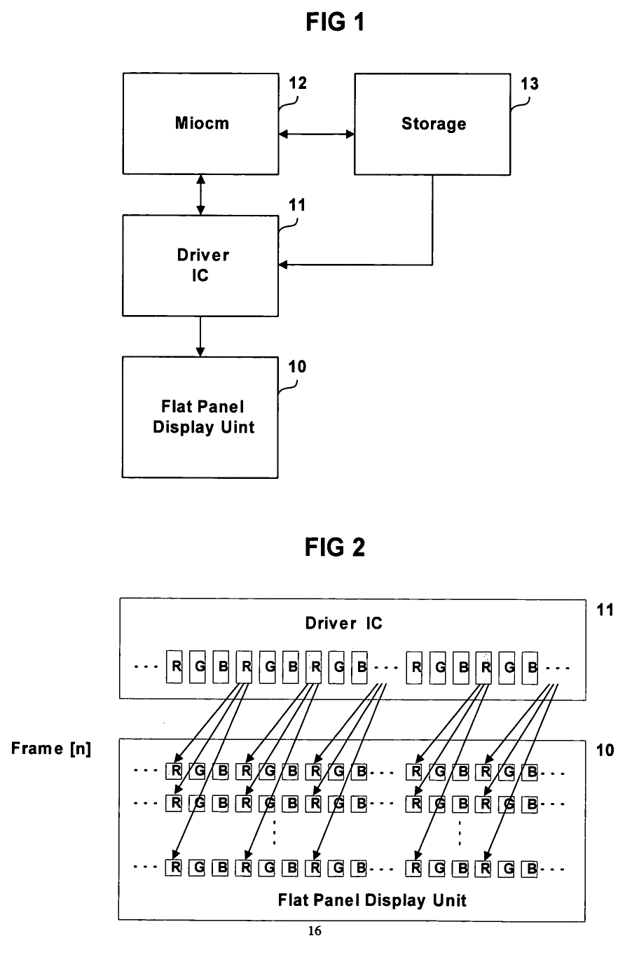

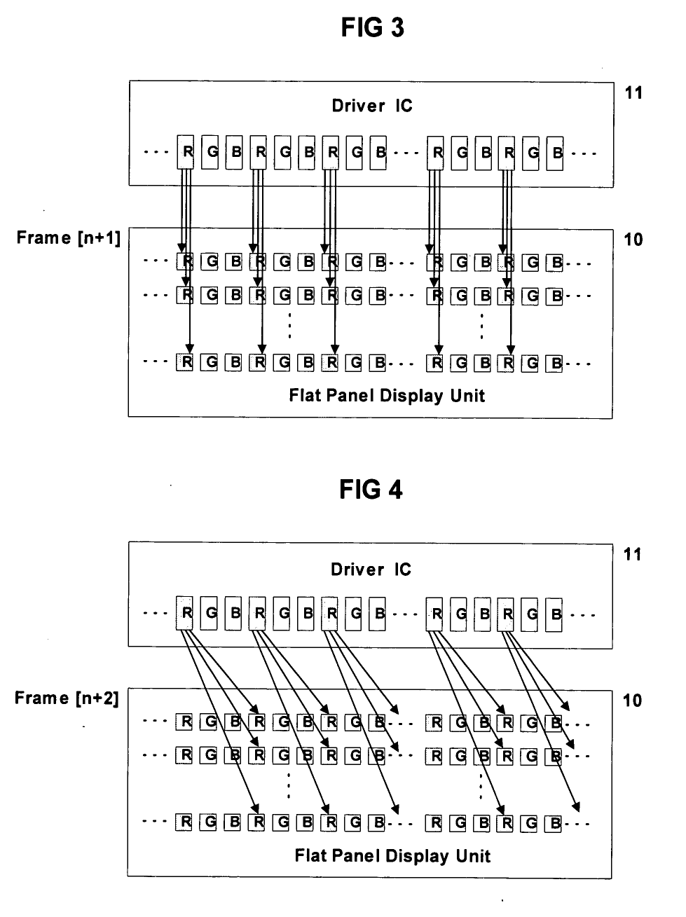

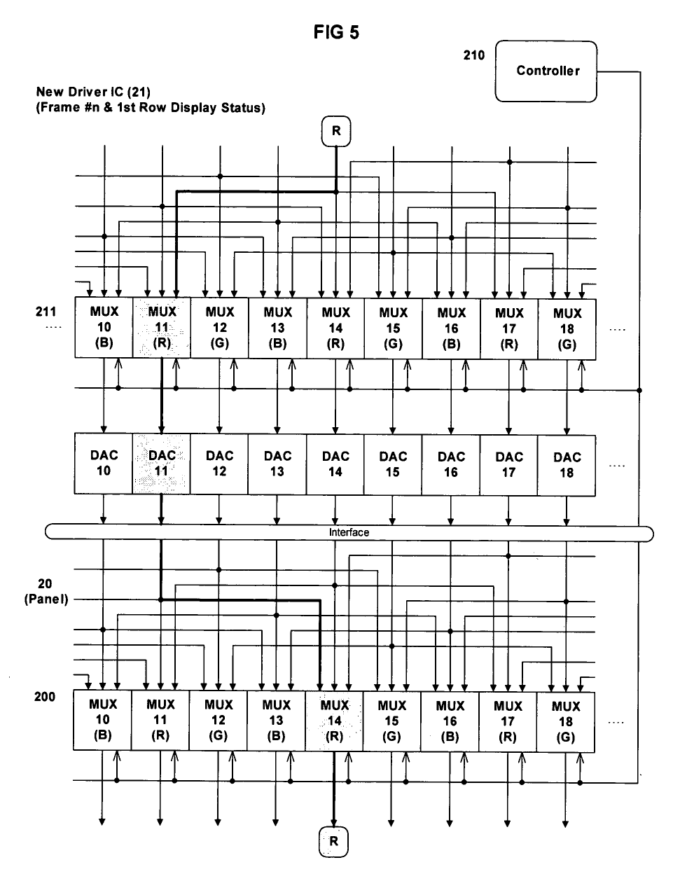

### DETAILED DESCRIPTION OF THE PREFFERRED EMBODIMENT

Preferred embodiments of a device and method for controlling the scanning directions of color signals in a flat panel display according to the present invention are described in detail with reference to the accompanying drawings below.

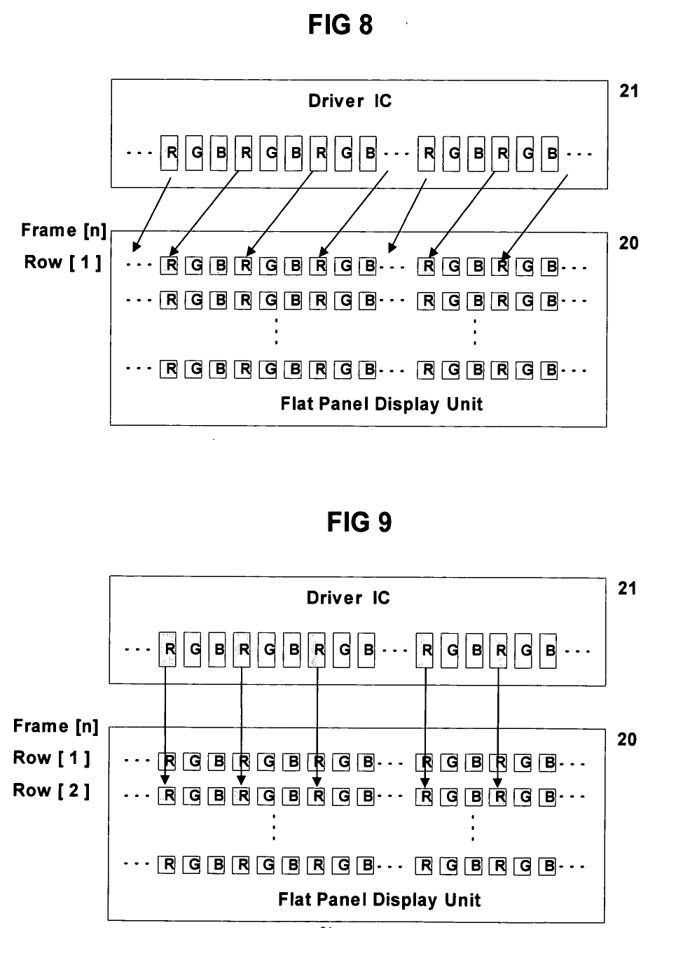

FIGS. 5 to 7 are diagrams illustrating embodiments of a device and method for controlling the scanning directions of color signals in a flat panel display according to the present invention, and FIGS. 8 to 10 are diagrams showing embodiments in which the scanning directions of color signals vary on a row basis for each frame in the flat panel display according to the present invention.

Meanwhile, as shown in FIG. 5, a new driver IC 21, to which the present invention is applied, includes, for example, a controller 210, a plurality of multiplexers 211, and a plurality of D/A converters 212. Furthermore, a flat panel display unit 20, to which the present invention is applied, includes a plurality of multiplexers 200 and light-emitting devices. In this case, high-performance AMOLEDs may be used as the light-emitting devices.

Furthermore, the driver IC 21 and the flat panel display unit 20 are connected to each other through an interface. The multiplexers 211, which are provided in the driver IC 21, and the multiplexers 200, which are provided in the flat panel display 20, are implemented using three-to-one multiplexers, each of which selectively outputs one of input signals. Hereinafter, the multiplexers 210 of the driver IC 21 are referred to as input multiplexers, and the multiplexers of the flat panel display 20 are referred to as output multiplexers.

Meanwhile, each of the input multiplexers 211 and the output multiplexers 200 selectively outputs one of three signals under the operational control of the controller 210. For example, when the color data of the first row of the Nth frame Frame [n] is displayed, the controller 210, as shown in FIG. 5, controls the operation of the respective input multiplexers and output multiplexers, and enables the digital color data to pass through a signal processing path shifted by three D/A converters.

For example, the controller 210, as shown in FIG. 5, controls the operation of the respective input multiplexers 211 and output multiplexers 200 so that a color signal R, which will be applied to the light-emitting device of a corresponding pixel via a fourteenth input multiplexer Mux 14, a fourteenth D/A converter 14, and a fourteenth output multiplexer Mux 14, is applied to the light emitting device of the corresponding pixel via an eleventh input multiplexer Mux 11, an eleventh D/A converter 11, and the fourteenth output multiplexer Mux 14.

Accordingly, when the color data of the first row of the Nth frame Frame [n] is displayed, the scanning direction of the color signal scanned from the driver IC 21 onto the flat panel display 20, as shown in FIG. 8, is shifted in the lower-left diagonal direction by a Red/Green/Blue (R/G/B) pixel group.

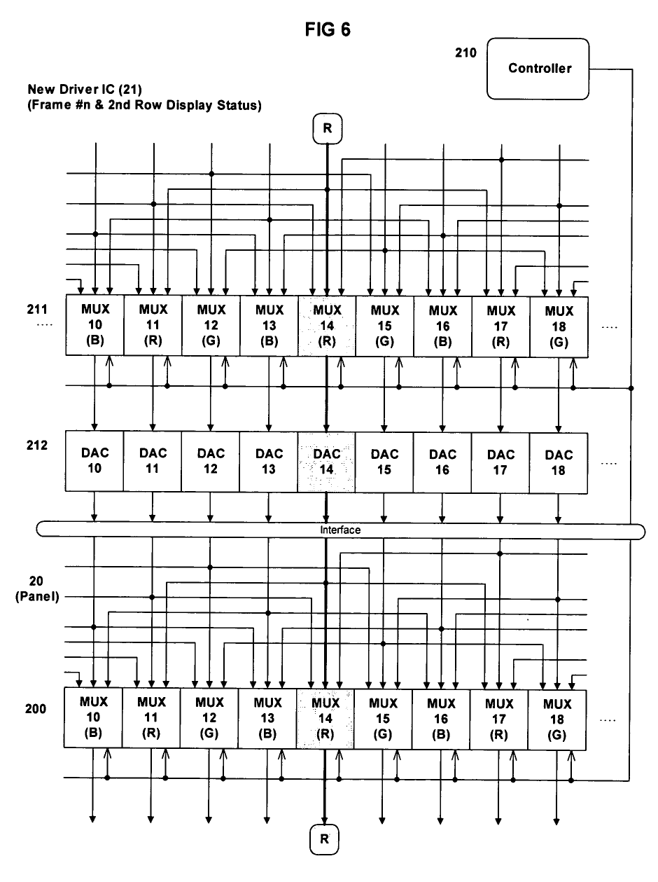

Meanwhile, when the color data of the second row of the Nth frame Frame [n] is displayed, the controller 210, as shown in FIG. 6, controls the operation of the respective input and output multiplexers 211 and 200 so that the color signal R is applied to the light-emitting device of a corresponding pixel via the fourteenth input multiplexer Mux 14, the fourteenth D/A converter DAC 14, and the fourteenth output multiplexer Mux 14.

Accordingly, when the color data of the second row of the Nth frame Frame [n] is displayed, the scanning direction of the color signal scanned onto the flat panel display unit 20, as shown in FIG. 9, is varied by the driver IC 21 in the original vertical direction.

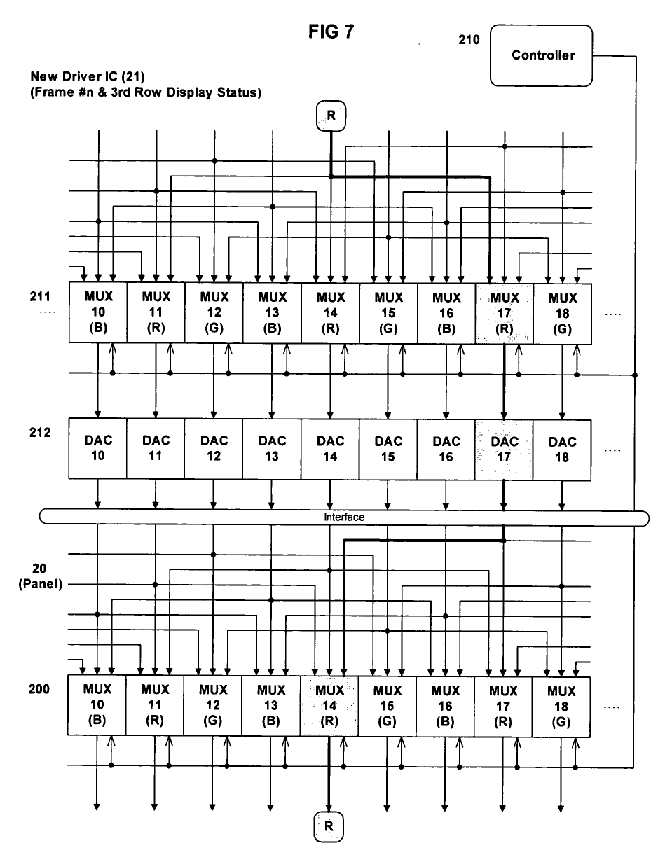

Furthermore, when the color data of the third row of the Nth frame Frame [n] is displayed, the controller 210 controls the operation of the respective input and output multiplexers 211 and 200, so that the color signal R, which will be applied to the light-emitting device of a corresponding pixel via the fourteenth input multiplexer Mux 14, the fourteenth D/A converter DAC 14, and the fourteenth output multiplexer Mux 14, as shown in FIG. 7, is applied to the light-emitting device of the corresponding pixel via a seventeenth input multiplexer Mux 17, a seventeenth D/A converter DAC 17, and the fourteenth output multiplexer Mux 14.

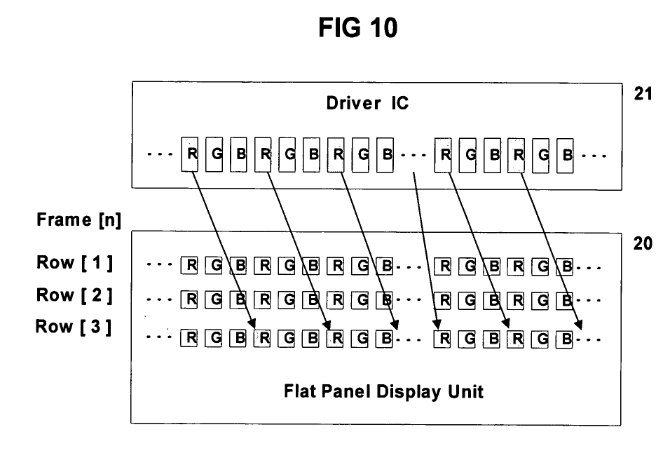

Accordingly, when the color data of the third row of Nth frame Frame [n] is displayed, the scanning direction of the color signal scanned from the driver IC 21 onto the flat panel display 20, as shown in FIG. 10, is shifted by an R/G/B pixel group in a lower-right diagonal direction.

Accordingly, the color signals R, which are applied to the light-emitting devices of corresponding pixels via the fourteenth output multiplexer Mux 14 of the flat panel display unit 20, can alternatively pass through different D/A converters, for example, the eleventh D/A converter DAC 11, the fourteenth D/A converter DAC 14 and the seventeenth D/A converter DAC 17, for the respective rows of the Nth frame Frame [n], so that the phenomenon, in which, when color signals pass only through the same D/A converter, vertical stripe pattern noise occurs on the screen of the display due to the differences between intrinsic characteristics of the respective D/A converters, can be more efficiently prevented.

Furthermore, when the scanning directions of color signals vary on a frame basis, the occurrence of gradient error caused by the diagonal stripe pattern noise can be efficiently prevented.

Meanwhile, the controller 210 can control the scanning directions of the color signals, which are scanned from the driver IC 21 onto the flat panel display 20, so that they vary for respective rows or for two or more groups of rows, in such a way as to control the operation of the respective input and output multiplexers 211 and 200.

Furthermore, the controller 210 can control the scanning directions of the color signals, which are scanned from the driver IC 21 onto the flat panel display 20, so that they vary in two or more different directions, selected from among the lower-left diagonal direction, the vertical direction, and the lower-right diagonal direction, in such a way as to control the operation of the input multiplexers 211 and the output multiplexers 200.

Accordingly, the present invention controls the scanning directions of analog color signals, which are scanned onto the flat panel display, so that they vary on a row basis for each frame, so that the occurrence of vertical stripe pattern noise and diagonal stripe pattern noise can be prevented, therefore color and luminance components, which are displayed on the flat panel display, can be stably maintained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling scanning directions of color signals in a flat panel display, the method comprising:
the first step of converting digital color data into analog color signals using a plurality of Digital-to-Analog (D/A) converters provided in a driver Integrated Circuit (IC); and
the second step of scanning the converted analog color signals onto a flat panel display unit, and controlling scanning directions of the color signals so that the scanning directions vary on a row basis for each frame.

2. The method as set forth in claim 1, wherein the second step controls the scanning directions of the color signals so that the scanning directions vary for respective rows or respective groups of rows of each frame.

3. The method as set forth in claim 2, wherein the scanning directions of the color signals vary in two or more different directions, selected from among a lower-left diagonal direction, a vertical direction, and a lower-right diagonal direction, at intervals of Red/Green/Blue (R/G/B) pixel groups of the flat panel display.

4. The method as set forth in claim 1, wherein the second step controls the scanning directions of the color signals so that the scanning directions vary on a row basis for each frame, in such a way as to control operation of respective input multiplexers, each of which selectively inputs one of a plurality of pieces of color data to a D/A converter, and output multiplexers, each of which selectively outputs one of color signals input by a predetermined number of D/A converters.

5. The method as set forth in claim 4, wherein the input multiplexers and the output multiplexers are three-to-one multiplexers each of which selectively outputs one of three input signals, and are configured to shift the color data or the color signals by three D/A converters.

6. The method as set forth in claim 5, wherein the output multiplexers select right input color signals when the input multiplexers select left input color data, the output multiplexers select left input color signals when the input multiplexers select right input color data, and the output multiplexers select central input color signals when the input multiplexers select central input color data.

7. The method as set forth in claim 6, wherein the flat panel display unit comprises the output multiplexers and Active Matrix type Organic Light Emitting Diodes (AMOLEDs), and the driver IC comprises the D/A converters and input multiplexers and a controller.

8. A device for controlling scanning directions of color signals in a flat panel display, the device comprising:
a plurality of D/A converters for converting digital color data into analog color signals;
a plurality of input multiplexers, each for selecting one of a predetermined number of pieces of digital color data to be input to the D/A converters, and inputting the selected digital color data to a corresponding D/A converter;
a plurality of output multiplexers, each for selecting one of color signals input through a predetermined number of D/A converters and outputting the selected color signal to a light-emitting device of a pixel; and
a controller for controlling scanning directions of the color signals so that the scanning directions vary on a row basis for each frame in such a way as to control operation of the respective input and output multiplexers.

9. The device as set forth in claim 8, wherein the controller controls the scanning directions of the color signals so that the scanning directions vary for respective rows or respective groups of rows of each frame in such a way as to control operation of the respective input and output multiplexers.

10. The device as set forth in claim 8, wherein the input multiplexers, the D/A converters and the controller are provided in a driver IC, and the output multiplexers and the light-emitting devices are provided in a flat panel display unit.

11. The device as set forth in claim 10, wherein the controller controls the scanning directions of the color signals so that the scanning directions vary in two or more different directions, selected from among a lower-left diagonal direction, a vertical direction, and a lower-right diagonal direction, at intervals of R/G/B pixel groups of the flat panel display, in such a way as to control operation of the respective input and output multiplexers.

12. The device as set forth in claim 8, wherein the input multiplexers and the output multiplexers are three-to-one multiplexers each of which selectively outputs one of three input signals, and shift the color data or the color signals by three D/A converters.

13. The device as set forth in claim 12, wherein the output multiplexers select right input color signals when the input multiplexers select left input color data, the output multiplexers select left input color signals when the input multiplexers select right input color data, and the output multiplexers select central input color signals when the input multiplexers select central input color data.

14. The device as set forth in claim 10, wherein the light emitting devices of the flat panel display are an AMOLEDs.
